(19) United States
(12) Patent Application Publication
(10) Pub. No.: US 2006/0037528 A1
(43) Pub. Date: Feb. 23, 2006

(54) Method and apparatus for intelligent highway traffic control devices

(75) Inventors: Shane M. Farritor, Lincoln, NE (US); Xiangrong Shen, Lincoln, NE (US); Jason Dumpert, Lincoln, NE (US)

Correspondence Address: SHOOK, HARDY & BACON LLP;INTELLECTUAL PROPERTY DEPARTMENT, 2555 GRAND BLVD, KANSAS CITY,, MO, 64108-2613, US

(73) Assignee: Board of Regents of University of Nebraska, Lincoln, NE (US)

(21) Appl. No.: 11/172,148

(22) Filed: Jun. 30, 2005

Related U.S. Application Data
(60) Provisional application No. 60/584,031, filed on Jun. 30, 2004.

(51) Int. Cl. G01N 31/22

(52) U.S. Cl. 116/200

(57) ABSTRACT

A method and system is disclosed for the deployment, reconfiguration and retrieval of robotic highway safety markers. The system includes one or more robotic safety markers, a base station or lead robot having a range-finder module for robotic safety marker localization, a communication module for master-slave communication with each robotic safety marker and means for path planning for the robotic safety markers. The system is controlled by a hierarchical control system having both global and local control.

### CROSS-REFERENCE TO RELATED APPLICATIONS

This application claims priority to commonly owned U.S. provisional application Ser. No. 60/584,031, filed Jun. 30, 2004, is incorporated by reference in their entity.

### TECHNICAL FIELD

The present invention relates generally to a method and system for intelligent highway control and more particularly to a method and system for a robotic highway safety marker deployment, re-configuration and retrieval.

### BACKGROUND OF THE INVENTION

The safety of highway construction and maintenance workers is an important issue. For every billion dollars spent on road construction, more than 33 people die in accidents related to that work. The nation's highway system is aging and is in need of constant repair will require increased maintenance and construction. This will result in more injuries.

Work zone housekeeping is one of the most important element in reducing accidents. Housekeeping involves tasks such as covering and uncovering signs and moving markers (barrels, cones, signs) as the work progresses. While housekeeping is important, it comes at a high cost. Worker time is required to set up and tear down hundreds of construction zone safety devices. Safety barrels or markers guide traffic and serve as a visible barrier between traffic and work crews. These markers often need to be deployed and retrieved at the beginning and end of each workday, which is time-consuming and dangerous since it is close to the passing motorists. Leaving the markers in open view, however, such as by moving them to the side of the road is unsafe since their constant presence may lead to driver complacency.

Significant research has been conducted investigating “smart” highways, such as the Intelligent Vehicle Highway Systems, that use technology to provide information to travelers, improve traffic control and congestion, and increase the efficiency of commercial vehicle and transit operations. Further, several projects have applied robotic technologies to highway construction equipment. For example, one project created a remotely driven dump truck that was used as a barrier by shadowing a vehicle during slow moving maintenance operations. Other projects developed an automated paving machine and a robotic paint removal system. Further, the Advanced Highway Maintenance and Construction Technology Research Center at the University of California, Davis has developed several automated highway maintenance systems including a laser-guided lane stripe painting machine, a tethered robot team for roadway crack sealing, and a flying teleoperated aerial bridge-inspection system.

Research has also been done in automated placement of safety devices. One system uses a tele-operated robotic device to apply raised, reflective pavement markers. Other systems have automated the placement and retrieval of warning cones. These systems consist of modified pickup trucks that place cones as the vehicles move down the road. In these systems, the markers are deployed serially, with one device used to deploy and retrieve each marker. The advantage of serial deployment is that the markers themselves do not need to be modified, and the cost and complexity of the overall system is not related to the number of markers deployed. The disadvantages are that the deployment time grows with the number of markers, and the markers cannot be reconfigured to adapt to a changing work zone.

A need thus exists for a “smart” work zone, which consists of automated traffic control devices, to improve safety. These robotic traffic control devices must be reliable and have a low per-robot cost. Reliability is important because a robot that malfunctions could create a significant hazard. Low cost is important because multiple safety markers are used and barrels are often struck by vehicles. The present invention is directed to robotic traffic-control devices, which are deployed and retrieved in parallel and adapt to changes in the work zone.

### SUMMARY OF THE INVENTION

The present invention is directed to the control and localization of one or more robotic highway safety markers. The robotic safety markers are sensor- and computationally limited robots that are controlled by a leader robot or mobile station with a desired formation in long-distance navigation. Complex sensing and computation are performed by the mobile station or leader robot while local control is distributed between the one or more robotic makers. Thus, individual robotic markers do not need high computational ability or high bandwidth communication or expensive localization and hazard-avoidance sensing. The robotic safety markers are automatically deployed and maneuvered to control traffic flow in highway work zones.

In accordance with one aspect of the present invention, the system comprises one or more robotic safety markers, a base station or lead robot having a range finder module for robotic safety marker localization, a communication module for master-slave communication with each robotic safety marker and means for path planning for each robotic safety marker. The system is controlled by a hierarchical control system having both global and local control. This control system centralizes the sensing and intelligence for the system in the lead robot.

In another aspect, the system comprises one or more robotic safety markers, each robotic marker having a global positioning system receiver and a communication module, and a lead robot having a communication module, which provides for user interaction, for master-slave communication with each robotic safety marker and means for path planning for each robotic safety marker. The system is controlled by a hierarchical control system having both global and local control.

In accordance with one aspect, a method for establishing a moving road construction work zone, which comprises a group of robotic safety markers following a leader robot. The safety markers maintaining a set formation or set distance of separation and bearing from the leader robot.

### BRIEF DESCRIPTION OF THE SEVERAL VIEWS OF THE DRAWINGS

The various features of the present invention and the manner of attaining them will be described in greater detail with reference to the following description, claims, and drawings, wherein reference numerals are reused, where appropriate, to indicate a correspondence between the referenced items, and wherein:

FIG. 1 is a high level block diagram for the general environment of the system of the present invention;

FIG. 2 is a schematic diagram for the robotic safety marker of the present invention;

FIG. 3 is a flow diagram for the local control system for a robotic safety marker of the present invention;

FIG. 4 is a flow diagram for the implementation of the local control task for the robotic safety marker of the present invention;

FIG. 5 is a flow diagram for the communication system for the robotic safety marker of the present invention;

FIG. 6 is a flow diagram for the implementation of the control system for the robotic safety marker of the present invention;

FIG. 7 is a table showing the scan data for the range finder module for the lead robot or base station of the present invention.

FIG. 8 is a perspective view of a robotic safety marker of the present invention;

FIG. 9 is a schematic diagram for the lead robot or base station of the present invention;

FIG. 10 is a flow diagram for the safety marker localization;

FIG. 11 is a schematic diagram for a second embodiment of the robotic safety marker of the present invention;

FIG. 12 is a schematic diagram for a second embodiment of the lead robot of the present invention;

FIG. 13 is a diagrammatical representation of two robotic safety markers relative to a leader robot in a third embodiment of the present invention.

FIG. 14 is graphical representation of a path of a robotic safety marker;

FIG. 15 is a graphical representation of the control mechanism for a third embodiment of the present invention;

FIG. 16 is a graphical representation of Bezier trajectory between the leader robot and the robotic safety marker; and

FIG. 17 is a graphical representation of angular motion for the robotic safety marker of the present invention.

### DETAILED DESCRIPTION OF THE INVENTION

The present invention is directed a method and system 10 for the control and localization of one or more robotic highway safety markers. The robotic safety markers are sensor- and computationally limited robotic markers that “follow” a leader robot or mobile station in a desired formation in long-distance navigation. Complex sensing and computation are performed by the mobile station or leader robot while local control is distributed between the one or more robotic makers. The system enables the robotic safety markers to be automatically deployed and maneuvered to control traffic flow in highway work zones

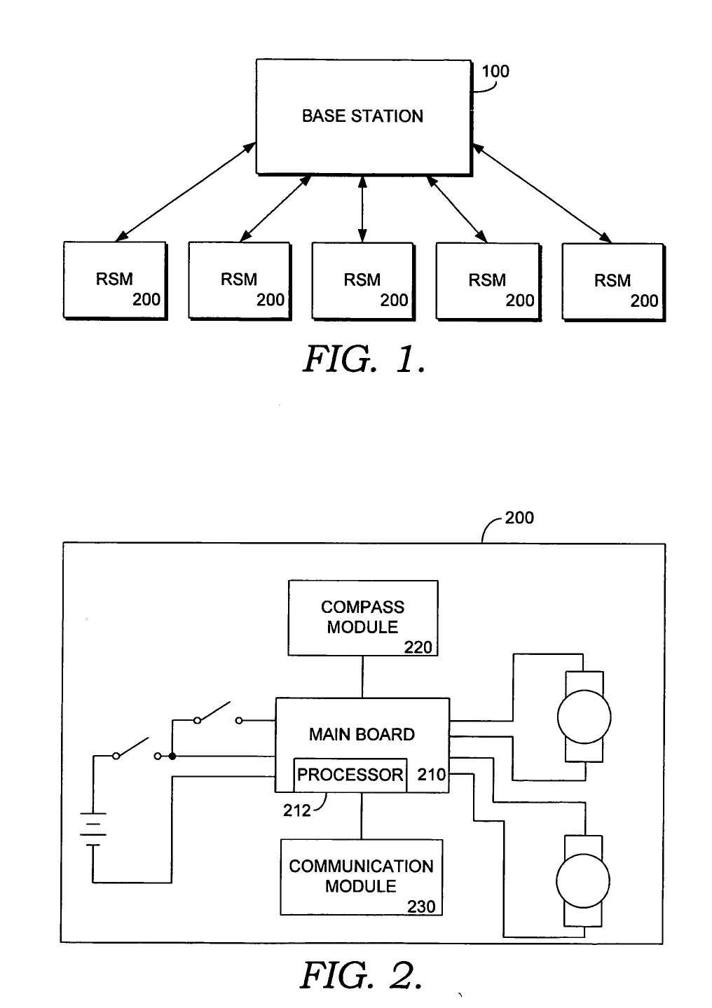

In a first embodiment, system 10 includes a base station or leader robot 100, one or more robotic safety markers 200, and a control system for controlling the positioning and re-positioning of the safety markers. In the exemplary embodiment shown in FIG. 1, the system includes one leader robot 100 and five robotic safety markers 200. It will be understood that the present invention is specifically envisioned for use in traffic control and for that purpose, one hundred or more robotic safety markers may be controlled by a lead robot or station 100.

As shown in FIG. 2, each safety marker 200 comprises a conventional drum 202 constructed of a flexible plastic or rubber material and standing approximately 130 cm in height and 50 cm in diameter. The drum 202 is brightly colored and may have reflective stripes (not shown) painted or adhered to its outer surface to increase visibility of the barrel to motorists at night. The drum 202 has a tubular side wall 203, a closed upper end 205 and an open lower end 207 together defining a hollow interior (not shown) of the drum. A handle 209 is formed integrally with the closed upper end 205 of the drum for grasping when lifting or moving the barrel.

This drum 202 is releasable secured to a base 204, which is generally circular and is sized radially (e.g., laterally) for seating the lower end 207 of the drum 202 on the base so that the base supports the entire safety marker 200 above the road surface. The upper surface of the base and the hollow interior of the drum 202 together define an enclosure for housing various operating components of the robotic safety marker as described later herein.

Each robotic safety marker 200 is further supported above the road surface in a generally horizontal orientation by a pair of drive wheels 208 and caster 210 mounted on the base 25 with the drive wheels in laterally spaced relationship with each other and the caster disposed rearward of and generally centrally between the drive wheels whereby the drive wheels and caster together form a generally triangular formation for supporting the marker 200. The drive wheels 208 and caster 210 are spaced relative to each other so that the center of gravity of the robotic safety marker assembly 200 is positioned within the triangular formation defined by the drive wheels and caster. Drive wheels 208 are preferably 20 cm-diameter wheels, which are independently driven by two DC motors 208. This enables the safety marker 200 to turn on any radius, including turning in place. Each motor further includes an optical encoder 212 to enable each marker 200 to determine its position over short distances. Electrically, each safety marker 200 is powered by a 12-volt lead-acid battery, which allows it to operate continuously for approximately 20 hours.

Each safety marker 200 is configured to be stable in 96 km/h (60 mph) winds, have a relatively low weight of less than 12 Kg. (approximately 26 lbs.), be capable of traversing slopes of up to 7% grade (4°) and traverse small obstructions.

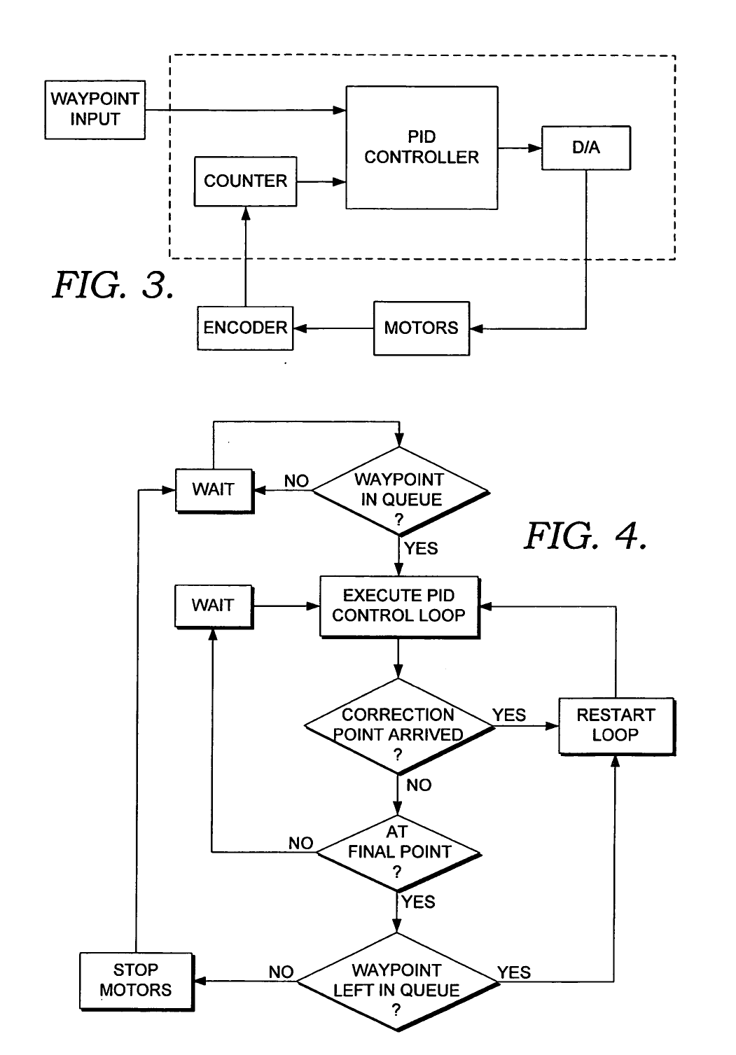

As shown in FIG. 3, each safety marker 200 further includes an electronic compass module 220, a communication module 230, and a main processor 240 to run the control system of the present invention, which will be discussed hereinafter. In the system of the present invention, the communication module 230 for each robotic safety marked enable communication between the leader 100 and individual robotic safety markers. No communication occurs between individual robotic safety markers. Preferably, communication module 230 is a 9XStream RF modules from Maxstream, Inc., and has frequency-hopping spread spectrum (FHSS) technology, standard serial digital interface connection, AT and binary command interface, 19200 baud transfer rate, and packet retries and acknowledgements.

To increase reliability of the system 10, an encoded RF “heartbeat” may be broadcast locally through communication module 230 or a separate communication system. A loss of this heartbeat causes motor power to be cut through redundant fail-safe electrical relays. Each robotic safety marker's position is further monitored by the robotic safety marker and the lead robot. Discrepancies in these redundant sensors (and processors) will cause either a local (an individual robotic safety marker) or global (heartbeat) shutdown. All communication between the lead and barrels uses a 16-bit CRC checksum to prevent erroneous commands.

A block diagram of the electronics for a robotic safety marker 200 is shown in FIG. 2. The main board 210 comprises the main processor 212, quadrature encoder interface hardware, H-bridge motor drivers, and a voltage regulator. The main processor 212 for the robotic safety barrel is for example the Rabbit 2000 microprocessor from Rabbit Semiconductor. The Rabbit 2000 is an 8-bit micro-controller with an instruction set derived from the Z-80 and Z-180 microcontrollers. Its features include: clock speed of up to 30 Mhz., 1 megabyte of code space, four levels of interrupt priority, with interrupt latency of 1J.IS @ 25 Mhz., 40 parallel I/O lines, 4 Serial Ports 6 Timers/Counters, and support for C programming language. The Rabbit 2000 microprocessor comes on the RCM 2000 core module, which features 512 Kb of SRAM and 256 Kb of Flash memory for program storage, namely: Initialization; Local Control; Communication and Acquisition of Compass Data. It should be understood that other microprocessors may be used, such as for example the Rabbit 3000, without departing from the scope of the invention.

Also on the main board 200 are two 1S7166 encoder interface chips and two 1MD18245 H-Bridge motor drivers. The external data bus on the RCM2000 module is used to interface with both the encoder interface chips and the motor drivers. The Rabbit 2000 includes 8 strobe lines. Each of the eight strobe lines is active for a 8 Kb block of the 64 Kb address space. This allows the devices to be individually addressed without adding hardware to decode the external address bus. The L87166 counter chips interface with the quadrature encoders mounted on each motor. These chips feature 24-bit counters and can be queried at any time by the processor 212 for the counter value. The controller converts these counter values into their corresponding wheel angles for use in the local controller.

Each DC motor for wheel 208 is driven by a LMD18245 H-Bridge motor driver. These H-bridges feature a 4-bit DAC for controlling motor current, as well as direction and brake inputs. These devices can deliver continuous output currents of up to 3 amps at supply voltages of up to 55 V. The main processor does not address the H-bridges directly. Instead, two 8N74HC377 Octal Latches are used to latch the 4-bit magnitude, direction, and brake bits for the H-bridges.

The leader robot or base station 100 includes a range-finder module 110 for safety marker 200 localization, a communication module 120 for master-slave communication with each safety marker and means for path planning. The system is controlled by a hierarchical control system having both global and local control. This control system centralizes the sensing and intelligence for the system in the lead robot 100. Local control is distributed; therefore individual robotic safety markers do not need high computational ability or expensive localization and hazard-avoidance sensing.

The base station 100 in the system 10 is preferably a mobile station that can self navigate. The station 100 may be a maintenance vehicle or a utility vehicle. Alternatively, it may be an autonomous mobile robot, such as the Companion, a mobile robot developed at MIT. The Companion is a modified electric wheelchair, which has motor-controlled, automobile-type (Ackermann) steering and a high-torque, DC brushed motor for drive. The Companion has a turning radius of approximately two feet allows for very tight maneuvers, which is very helpful for most proposed applications of the system 10.

The base station 100 includes a main processor consisting of at least a 133 Mhz Pentium personal computer in a PC-104 form factor. Expansion cards include VGA video, 10 Base-T Ethernet, 48-Line digital I/O, Motion Engineering, Inc.'s 4-axis motion control, 16 analog inputs, and 2 analog outputs.

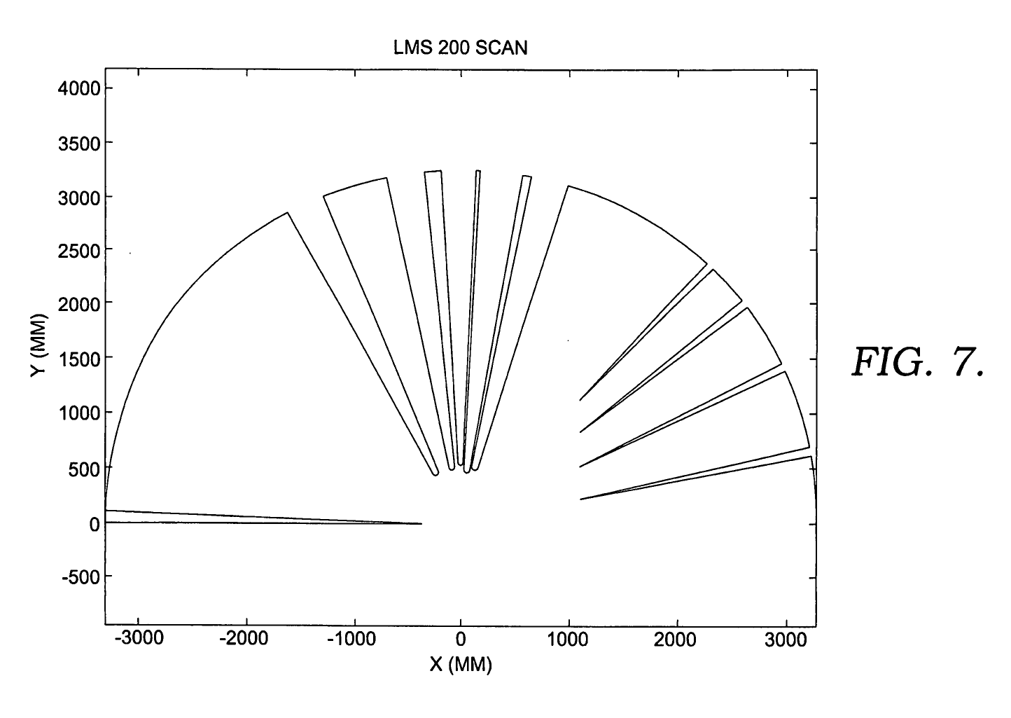

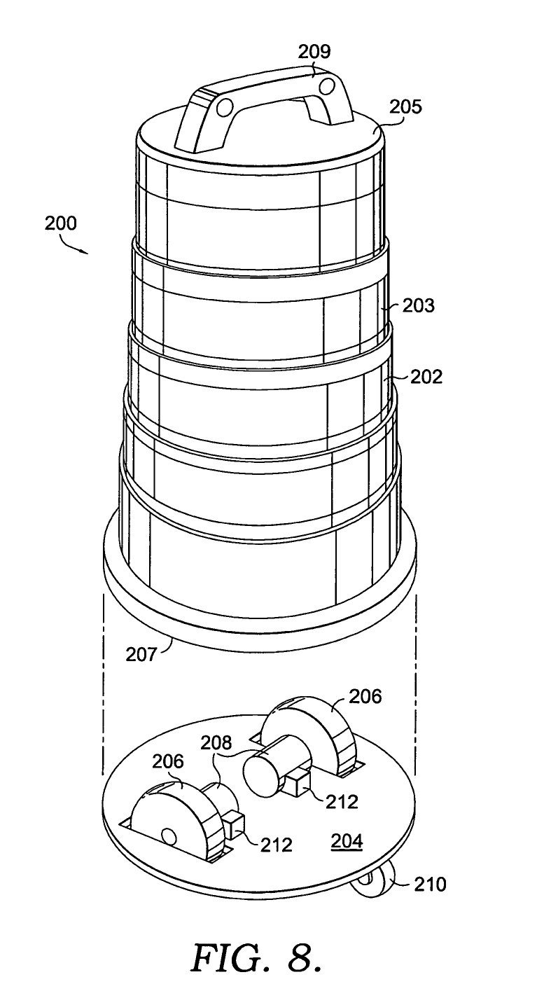

The range-finder module 110, which is used to determine the position of each safety marker 200, is preferably a non-contact laser measurement system, such as the LMS200 available from Sick, A. G., Dusseldorf, Germany. The range finder module 110 scans its surroundings two-dimensionally in a fan-shaped scan area, as shown in FIG. 7. This module measures distance by a time-of-flight method. Preferably, it features a 180-degree scanning angle, a 0.5 ° angular resolution, 10 mm resolution, and ±35 mm measurement accuracy. The module 110 communicates with the host PC via a serial interface. The device is powered by a 24 V supply, and draws approximately 800 mA when in use. The maximum range of the device is approximately 32 meters.

The lead station 100 further includes a communication module 120, such as the 9XStream RF transceivers available from Maxstream, Inc. of Orem, Utah. Communication module 120 enables communication between the lead station 100 and the communication modules 230 for each robotic safety marker 200, as will be described hereinafter. Module 120 is a frequency hopping spread spectrum (FHSS) wireless module preferably operating in the 902 MHz to 928 MHz unlicensed ISM band.

Communication module 120 preferably supports three levels of addressing to communicate between modules. Each module has a Vendor Identification Number (VID). Only modules with the same VID can communicate with each other. The second addressing mode is the network ID. Different networks use a different pseudo-random frequency hopping sequence. If packets from different networks “collide” on the same frequency, the next hop for each device will be on a different frequency so concurrent collisions do not occur. The third addressing method uses two 16-bit, user configurable parameters: module address and module address mask. Modules with the same address can communicate with each other. Modules on the same network with different parameters will detect data from other modules to maintain network synchronization, but data received will not be transmitted out from the serial port. The module address mask is used when a packet is received by the module. The address of the sending module is logically ANDed with the module address mask of the receiving module. If the result matches either the module address or module address mask of the receiver, the packet is accepted. If no match occurs, the packet is discarded.

The module addresses and address masks are configured so each safety marker will receive only messages from the lead robot 100. This is accomplished by the lead robot changing its module address to match the safety marker with which it is communicating. The address mask on the lead robot is set such that it can always receive messages from any robot, regardless of its current module address.

The system 10 comprises a centralized sensing, localization and control for the follow-the-leader movement of the lead station 100 and the group of robotic safety markers 200. The complexity of sensing, control and computation is relegated to the lead station 100, while the group of robotic safety markers perform relatively simple local operations under the leader station's localization and guidance.

In order to operate the present invention, each robotic safety marker must be localized by the lead station 100. The lead robot or base station 100 is responsible for the following tasks: localization of robotic safety markers, global path planning, and communicating new positions to each robotic safety marker.

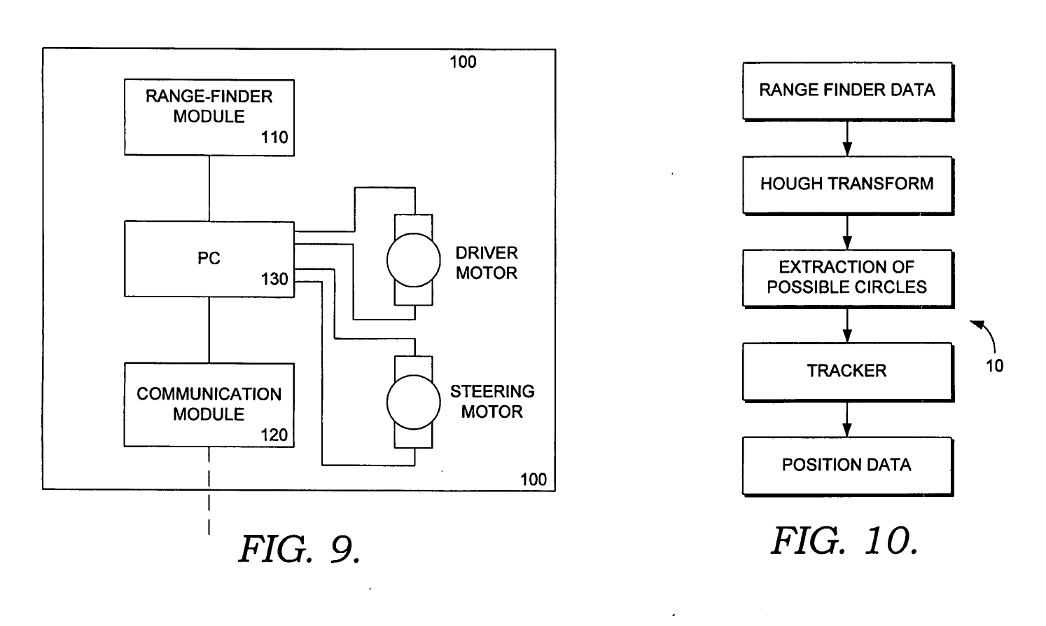

Each safety marker 200 relies on a dead-reckoning technique to navigate. This technique accumulates error rather quickly. Consequently, the robotic safety markers 200 must rely on an external means to find their exact location. The lead robot accomplishes this task by polling the range finder module 110 to determine the distance data. The cylindrical safety markers 200 create a circular pattern in the two-dimensional plane of the laser scanner, as shown in FIG. 9. Each follower safety marker is localized with a modified circle detection Hough transform algorithm, as shown in FIG. 10. The localization algorithm can be broken down into two parts: transformation of image space to parameter space using the Hough transform and analysis of the parameter space to find possible circles to thereby locate the barrel center for each safety marker. The position of each robotic safety marker is preferably estimated every 60 milliseconds, which includes both scanning and algorithm processing. When the periodic scanning is started, the tracker simply matches the previous position to the closest possible barrel center. Using this method, lead robot 100 determines the exact location of each safety marker and tracks each safety marker in real-time.

This method results in a highly accurate positional data for each robotic safety marker. But, heading information is more difficult to obtain. Therefore, an electronic compass module 220, such as the Vector 2XG from Precision Navigation, is installed on each safety marker 200. The compass is a two-axis magnetometer that measures magnetic fields in a single plane. It is accurate to 2° and has a resolution of 1°.

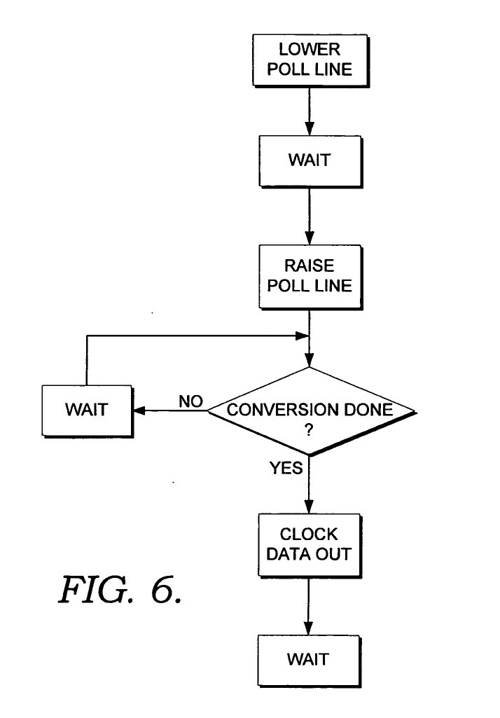

The processor 212 for each robotic safety marker 200 polls the compass module 220 for compass heading information. The processor stores the heading information in an array that contains the current readings as well as the 20-previous readings. Since the maximum output rate of the compass is only 5 Hz, the sequence of steps must not tie up the processor waiting on the device to send the data. In FIG. 6, the states labeled “Wait” represent places where the compass task yields the processor to other tasks. Compass module 220 communicates with the processor 212 of main board 210 of the safety marker 200 over a synchronous serial port. The output format is either absolute heading or raw data from each magnetic field sensor.

In a first embodiment of the present invention, each robotic safety markers will be deployed to a first specific location or waypoint and remain there until they need to be re-deployed to a second location. This could be an immediate re-deployment or it could be after several hours. Each robotic safety marker has limited sensory capability, and relies on the lead robot or base station 100 for guidance. The leader 100, for this embodiment, executes a global path plan for each robotic safety marker.

This involves taking the initial position and orientation for each safety marker 200 and the desired final position for each marker and planning a path, and implementing a Jacobian Cartesian scheme. This is a common approach to robot control where an error is created in Cartesian space using a desired Cartesian position and the measured position. The error in the joint space is then acted upon by a traditional PID controller to create torque commands for each the safety robot's motors. Desired positions are created with a local parabola between the initial position and orientation and the desired waypoint. As the input to the controller, the desired positions are created based on a trajectory-generation algorithm that dictates a series of desired waypoints along a path with equal execution time interval, so that the controller can be implemented digitally at a fixed cycle. The trajectory-generation algorithm, like the global trajectory planner, consists of two parts: path generation and waypoint generation. As the first step, a path is generated to connect the initial position and the desired final position. Then a certain time-distance relationship along the path is applied to find a series of waypoints with equal execution time interval as the input to the controller. A known approach is to create a polynomial smooth path, with the initial direction coinciding with the robot's initial orientation.

The primary obstacles for the markers are other safety markers. The roadway may have identifiable areas that cannot be traversed, such as potholes or a sharp drop off at the pavements edge, but these areas can be inputted into the memory of the personal computer by an operator and accounted for during path planning. A path can be plotted to the goal while avoiding impassable regions using several known methods (e.g. tangent graphs). Acceleration and velocity constraints limit the curvature of the path. Preferably, a behavior-based approach is employed where priority is given to the robotic safety marker that must travel the greatest distance. Since all robots are similar, this ensures that the time required to complete the total motion is minimized.

The generated waypoints are communicated to each robotic safety marker through communication module 120. The processor for each robotic safety marker runs a local control task periodically after an initialization task is complete. Processor 212 runs the initialization task when the robotic safety marker is powered up or reset. This task is responsible for configuring the external I/O bus for interfacing with the encoder and H-Bridge hardware, and configuring and opening the serial port to interface with the communication module 230. The initialization task then configures the LS7166 counters and sets the initial value. Finally, both motors for the wheels are set to zero speed and the brake is turned on. This all happens within a few milliseconds of powering on, so the robot will not move randomly at power on and reset.

The processor 212 for each marker 200 then removes a waypoint from a queue, calculates the final position, and then executes the motion for the robotic safety marker to the waypoint. Each barrel robot receives a waypoint As shown in FIG. 4, the processor, during the local control task, waits until a waypoint (consisting of a x- and y-position) is sent from the lead robot 100. When a waypoint arrives, the communication task places it in a queue. The processor removes the waypoint from the queue and begins executing the movement to the waypoint. During the execution of this movement, an update command can be sent from the lead robot 100. This command causes the robotic safety marker to recalculate its path and start moving to the new waypoint.

A local planning and control scheme is used to analyze the waypoint and calculate the movements for the robotic safety marker. In this analysis, each robotic safety marker is constrained by its initial position and waypoint position. The local controller requires that initial direction of travel is locally forward, but does not constrain the final orientation. A Proportional-Integral-Derivative (PID) controller is used to guide the robot to the waypoint. The desired wheel angles, calculated from the local plan using known algorithms, are input to the controller and the PID controller generates the torque commands for each wheel of the robotic safety marker. The use of local control allows low bandwidth communication, and hence the use of an inexpensive transceiver, since only the waypoints need to be transmitted to each safety marker.

The local controller further evaluates whether other waypoints have arrived during travel to the previously acted-on waypoint. If not, the controller commands the robotic safety marker to stop. If another waypoint has arrived, the processor re-calculates a final position, and the robot moves to the new point without stopping.

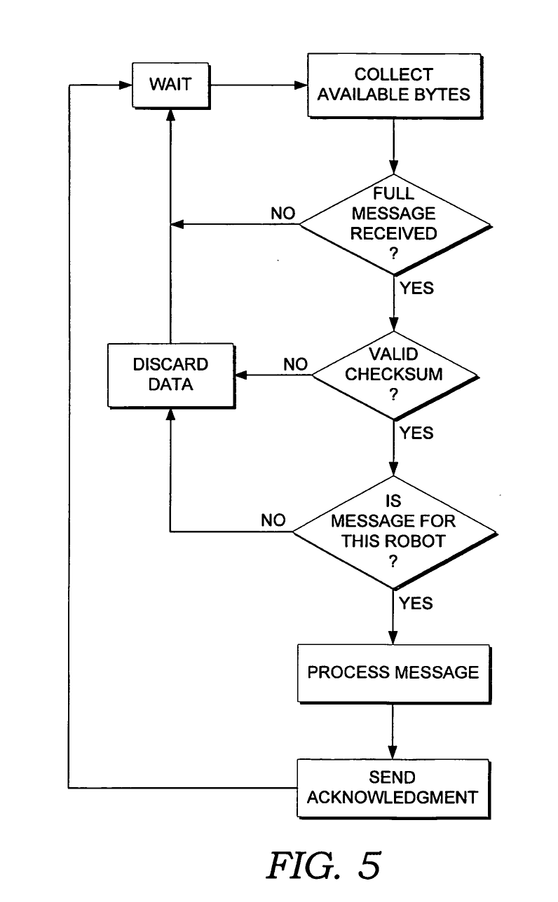

As shown in FIG. 5, the processor's communication task is responsible for collecting points from the serial port buffer, assembling them into a message, checking if the message is valid, and then processing the message. A serial port interrupt subroutine (ISR) is responsible for placing received bytes from the serial port into a circular buffer. The processor periodically checks how many bytes have been received and places these bytes into a buffer. When an entire message has arrived (20 bytes), a 16-bit checksum is computed and compared with the message checksum. If the checksums do not match, the message is discarded and a no-acknowledgement message is sent. If the checksums match, the message is processed, and an acknowledgement message is sent to the base station.

By using real-time scheduling, it can be guaranteed that all tasks will meet both logical and temporal correctness requirements. Consequently, the system will be more reliable and safer. In the robotic safety marker system 10, rate-monotonic (RM) scheduling is used. Under RM scheduling, tasks with smaller periods have higher priorities.

The robotic safety marker can be classified as a digital controller. As shown in FIG. 3, this controller (a PID controller) uses two inputs (encoder values and input waypoint) to compute the control output (motor torques). The period of the PID task is used by the processor for each robotic safety marker in calculating the control law. If this period is not constant, the controller could become unstable. By using a real-time scheduler, it can be guaranteed that the period is constant.

The first step in implementing the task set using a real-time scheduler is timing analysis of the task set. The three tasks are: Local Control, Communication, and Compass Read. These tasks are ported to the Rabbit 2000 processor through an I/O port and the execution times are analyzed. Each task is associated with a different bit on the I/O port. When the task becomes active, the bit is set to ‘1’ and when the task becomes inactive, the bit is set to ‘0’. In this way, it becomes easy to measure the execution time with an oscilloscope.

The task set received by each robotic safety marker is preferably implemented using μC/OS-II, a real-time kernel, which is a portable, scalable, preemptive, real-time, deterministic, multitasking kernel. Its operating system can be scaled to include only the needed components. Source code is provided with the kernel, so the user can adapt it to the design at hand. The kernel supports up to 63 tasks, each with a unique priority. The operating system can be adapted to run both static and dynamic real time schedulers. As mentioned before, rate-monotonic scheduling was chosen for this system. A hardware timer in the system (in this case, Rabbit 2000), is set to generate periodic interrupts.

When the tick interval elapses, a function call is made to OSTimeTick. When this function is called, the highest priority available task is made ready to run. Tasks are also made ready to run when another task calls OSTimeDelay. OSTimeDelay lets the operating system know that the job is done executing. The interval for the tick value, 1/16 s was set based on the timing requirements for the PID controller.

μC/OS-II also enables several means of inter-task communication. One of these is the message mailbox. A mailbox is used by the communication task of each robotic safety marker 200 to pass waypoint information to the local control task. When the local control task is not executing the PID loop, it waits on a mailbox, by calling OSMboxPend. The task remains inactive until a new waypoint arrives and is placed into the mail box by the communication task calling OSMboxPost. The PID loop then executes one iteration per period. At the end of each period, the task calls OSMBoxPeek. This function does not block if the mailbox is empty, as with OSMboxPend. If the communication task has placed another waypoint into the mailbox, the PID loop restarts and proceeds to the new point. If the mailbox is empty, the local control task continues with the current loop.

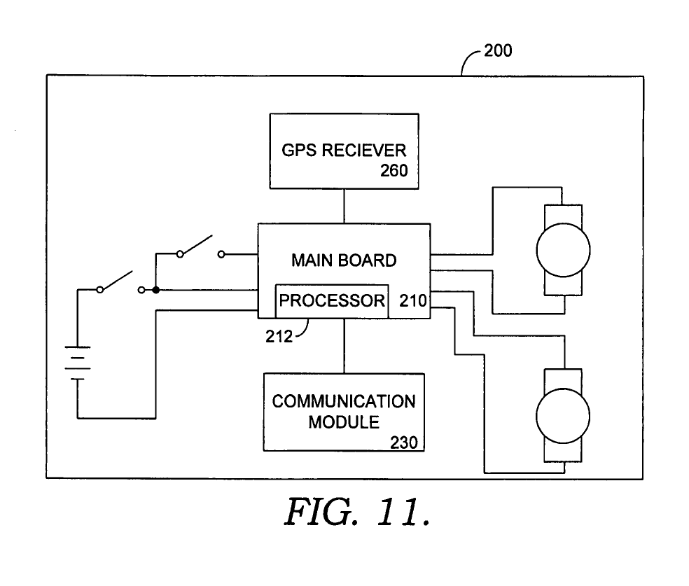

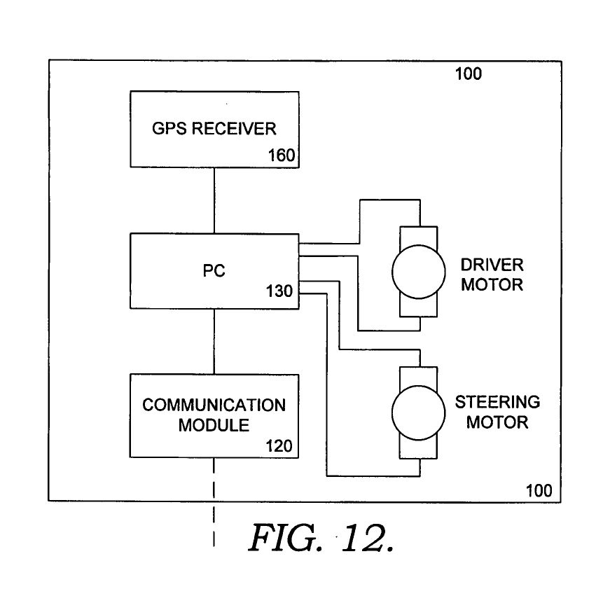

In an alternative embodiment of the present invention, the range-finder module 110 of the lead station 100 is replaced by a global positioning system. In this embodiment, both the lead robot or station 100 and each robotic safety marker 200 further include a global positioning receiver, as shown in FIG. 11. The system is designed with previously described distributed planning and control approach and reduces the per-robot cost (several barrel robots are needed and they are often struck by traffic) by centralizing the intelligence and sensing while keeping communication bandwidth low by distributing local control.

In this embodiment, each safety marker 200 still relies on a dead-reckoning technique to navigate, with the resulting accumulated error. Thus, the robotic safety markers must rely on an external means to find their exact location. This is accomplished through a global positioning system (GPS) receiver 260 mounted to each safety marker 200. The GPS information for each safety marker is sent to the lead robot or station 100 through communication module 230. The lead robot 100 is likewise equipped with a GPS receiver 160. This GPS information can be combined to obtain accurate differential readings. The lead robot then computes the distance data to determine positional relativity of each safety marker with respect to the lead robot. This method results in a highly accurate positional data for each robotic safety marker. But, heading information may still be difficult to determine. Therefore, the compass module 220 is utilized to provide heading information to the lead robot. This alternative embodiment otherwise is similar to the previously described embodiment for the system 10 of the present invention.

In yet another alternative embodiment of the present, a system 500 is particularly useful where a group of barrel robots autonomously follow a slow-moving maintenance operation, eliminating the need to create enormous worker zones for tasks performed over long distances. Such tasks include lane striping, mowing, or asphalt overlay. The main challenge is that simple sensor-limited followers do not have the capability of localization and navigation because of their lack of necessary on-board sensing, computation, and communication bandwidth.

To address this challenge, system 500 includes centralized sensing, localization and control method for follow-the-leader movement. The complexity of sensing, control and computation is relegated to the leader while followers only perform simple, local operations under the leader's localization and guidance. To guide these extremely sensor-limited followers during the long distance travel, the leader robot estimates the pose of followers and commands their motion.

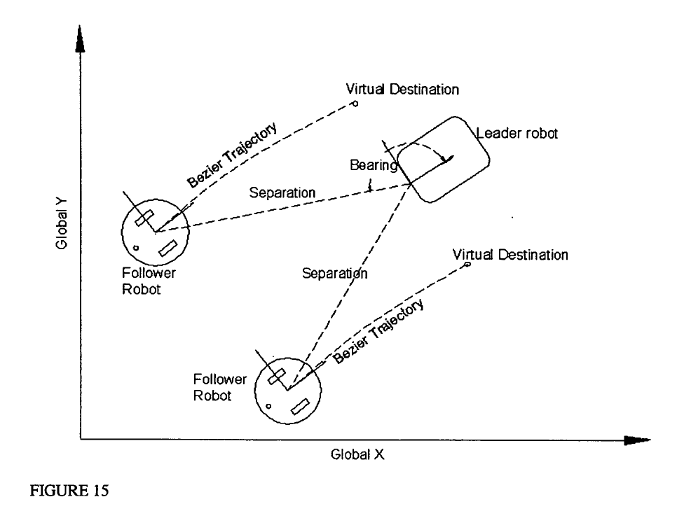

In this alternative embodiment, each follower, i.e., each safety marker 200, attempts to maintain a desired separation and bearing with respect to leader, i.e., lead station 100. To maintain this geometric formation, a virtual destination is assigned for each follower 200, as shown in FIG. 15. A cubic Bezier trajectory is defined between the follower and this virtual destination to allow the robotic markers to follow the lead station 100. The trajectory is updated in real time as the virtual destination varies as the lead station 100 moves. Only positional data related to the Bezier trajectory and the velocity of the lead station 100 is communicated from lead station 100 to the follower markers 200.

The follower robots 200 estimate their global position and orientation via dead reckoning. As previously discussed, errors (due to a variety of issues such as wheel slippage) are accumulated over time and thus dead reckoning is only reliable for short distance navigation. This localization method is unacceptable for long travel. Leader station robot 100 has a precise positioning system, such as the range-finder module or alternatively accurate global position localization or differential global positioning localization. The leader 100 localizes the group of sensor-limited followers using a single laser rangefinder or global positioning geocodes from each marker. Such a method is straightforward in determining the position of the follower robots, but the orientation of the follower robots is more difficult.

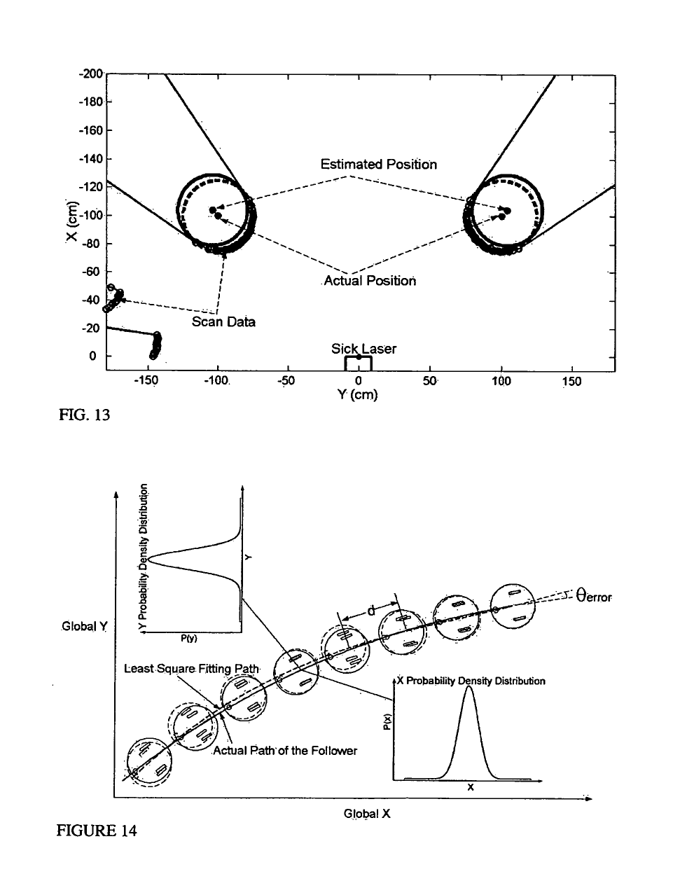

The position estimation error is mainly a result of the error in the distance measurements from the laser scanner (˜1.5 cm rms). The optical properties of the target surfaces can also affect sensing performance. Using the Hough transform algorithm, a statistical experiment shows the estimation error in both X (FIG. 13 top) and Y (FIG. 13 bottom) position is approximately normally distributed with standard deviation less than 0.2 cm. Here the actual follower robot 200 position is 100 cm behind the leader robot (x=−100 cm) and 100 cm to the left (y=100 cm). Coordinates are defined relative to the leader.

With this information, let Pᵣ=(Xᵣ, Yᵣ)^{T} be the measured relative position of the follower with respect to the leader robot, P_{L}=(X_{L}, Y_{L})^{T} and θ_{L} be the pose of the leader robot with respect to a global coordinate system. The global position of each follower can be calculated from Eq. (1):

$${P}_{F} = ( \begin{matrix}cos {θ}_{L} & - sin {θ}_{L} \\ sin {θ}_{L} & cos {θ}_{L}\end{matrix} ) {P}_{r} + {P}_{L} \qquad ( 1 )$$

The global position estimates of Eq. 1 will be used over time to track the motion of the follower robots 200 with respect to the leader 100. This data is then translated into estimates of the follower's orientation using a polynomial least squares method.

First a cubic polynomial function is adopted to approximate the follower's path based on recent global positions of the follower. A cubic polynomial is used because the follower robot's local trajectory generation uses a cubic Bezier curve and Bezier curve use Bernstein polynomials of third degree as the basis function. The follower robot's path is approximated by Eq. (2):
Y=a₀+a₁X+a₂X²+a₃X³ (2)
Where (X, Y) is the global position of the follower and a₀, a₁, a₂ and a₃ are the coefficients of the cubic polynomial function.

Now, P_{F}(t), P_{F}(t−1), P_{F}(t−2), . . . P_{F}(t−n+1) are n recent tracked global positions of the follower robot(s) with equal distance (d) between each location and t denotes the current time step. Preferably, eight positions (n=8) are used to reduce the effects of the error at any given location and a least squares fit is used to approximate these eight positions with the cubic polynomial function. The coefficients a₀, a₁, a₂ and a₃ can hence be obtained by solving a series of linear equations using Gaussian elimination. Then the approximate orientation θ_{L} is evaluated from Eq. (3) by differentiating Eq. (1):

$$\begin{matrix}\frac{ⅆ Y}{ⅆ X} {\vert}_{{X}_{{F}^{( t )}}} = {a}_{1} + 2 {a}_{2} X + 3 {a}_{3} {X}^{2} \\ {θ}_{L} = atan ( \frac{ⅆ Y}{ⅆ X} {\vert}_{{X}_{{F}^{( t )}}} )\end{matrix} \qquad ( 3 )$$

Leader robot 100 may obtain any orientation (i.e. it could drive in circles). Therefore the cubic polynomial function requires the dependent variable Y has at most one value for any specific value of the independent variable X. This requires that the follower robot's tracked positions must be monotonically increasing or decreasing along the global X or Y axis (or another suitable set of axes).

The orientation estimation becomes better and much more certain with increasing radius. Thus, a minimum turning radius of 150 cm with the standard deviation 1.13 degrees is a good choice for the given path and sensor error. This radius creates an expectation that 99.9999998% of the orientation estimates will be within six standard deviations (6.78 degrees) of either side of mean error (−0.93 degree). Therefore, the cubic polynomial least squares method can estimate the orientation of the follower robot with accuracy if the radius of the arc is greater than 150 cm.

For this alternative embodiment, a simple follow-the-leader formation-keeping control system is employed. It is based on the localization outlined in the previous sections. Each follower attempts to maintain the desired separation and bearing with respect to the leader robot. As shown in FIG. 15, to maintain this geometric formation, a virtual destination is assigned for each follower. Then a cubic Bezier trajectory is defined between the follower and this virtual destination to allow the robots to follow the leader. The trajectory is updated in real-time as the virtual destination varies as the leader robot moves. This approach keeps communication bandwidth very low since only the positional data related to the Bezier trajectory and the velocity of the leader robot 100 is communicated to the follower safety markers 200. A simple PID velocity controller is executed by the followers to track the Bezier trajectory with the desired linear velocity. This keeps simple computational requirements for the follower robotic safety markers.

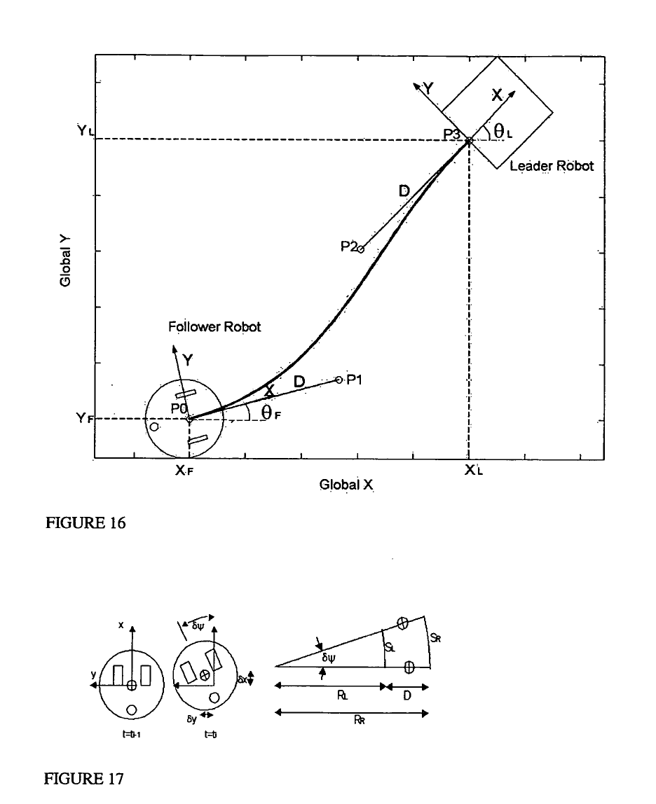

A cubic Bezier curve results from the weighted sum of four control points (P₀, P₁, P₂, and P₃) as shown in FIG. 16. The shape of curve can be easily deformed by modifying the relative locations of these points. Given the global pose of the leader robot 100 (X_{L}, Y_{L}, θ_{L}) and follower robotic safety marker 200 (X_{F}, Y_{F}, θ_{F}), the final position and orientation (X, Y, θ) with respect to the local coordinate system (local to the follower robot) can be calculated from Eq. (4) (coordinate systems defined in FIG. 16):

$$\begin{matrix}[ \begin{matrix}x \\ y\end{matrix} ] = ( \begin{matrix}cos ( - {θ}_{F} ) & - sin ( - {θ}_{F} ) \\ sin ( - {θ}_{F} ) & cos ( - {θ}_{F} )\end{matrix} ) [ \begin{matrix}{X}_{L} - {X}_{F} \\ {Y}_{L} - {Y}_{F}\end{matrix} ] \\ θ = {θ}_{L} - {θ}_{F}\end{matrix} \qquad ( 4 )$$

Then the local cubic Bezier trajectory is defined by Eq. (5):

$$\begin{matrix}P ( q ) = {( 1 - q )}^{3} {P}_{0} + {( 1 - q )}^{2} {qP}_{1} + ( 1 - q ) {q}^{2} {P}_{2} + {q}^{3} {P}_{3} \\ Where {P}_{0} = [ \begin{matrix}0 \\ 0\end{matrix} ] , \\ {P}_{1} = [ \begin{matrix}D \\ 0\end{matrix} ] , \\ {P}_{2} = [ \begin{matrix}x - D cos θ \\ y - D sin θ\end{matrix} ] , \\ {P}_{3} = [ \begin{matrix}x \\ y\end{matrix} ] , q ∈ [ 0 , 1 ] , \\ D = ‖ {P}_{0} - {P}_{1} ‖ = ‖ {P}_{2} - {P}_{3} ‖ .\end{matrix} \qquad ( 5 )$$

To determine P₁ and P₂, the distance ∥P₀−P₁∥ and ∥P₂−P₃∥ are assumed to be equal and is simply given D=α*∥P₂−P₃∥. Since the initial curvature of the Bezier trajectory depends on the choice of D and this curvature affects the performance of the local velocity controller in the follower, α=0.4 is chosen (from experimental experience). An important property is that the Bezier curve is tangent to both vectors P₁−P₀ and P₃−P₂ as in FIG. 16. Thus, if the leader robot moves in straight line, the follower robots can follow their desired positions in the geometric formation.

The design of a local controller for each robotic safety marker is critical to follow the leader robot with a desired geometric formation. When the follower robot 200 receives its pose information from the leader's communication module 120, it also receives the linear velocity of the leader station 100. The follower 200 then defines the Bezier trajectory and tries to track the trajectory with a linear velocity v. The velocity v is adjusted with a factor if the length of Bezier curve is different from the desired separation between the follower and virtual destination. The length L of the Bezier trajectory is calculated numerically using Simpson's rule. The total time to follow the full Bezier trajectory is then calculated from Eq. (6):

$${T}_{total} = \frac{L}{V} \qquad ( 6 )$$

And the parameter q to the control time t is defined by a simple linear function (Eq. (7)) between q and t.

$$q ( t ) = \frac{1}{{T}_{total}} t \qquad ( 7 )$$

Therefore, when t varies in the range [0, Tₜₒₜₐₗ], the parameter q varies between [0, 1]. In each cycle of the control loop, the curvature of the Bezier curve and the angular velocity can be calculated by Eq. (8) and (9):

$$\begin{matrix}κ ( t ) = \frac{\frac{ⅆ x}{ⅆ q} \frac{{ⅆ}^{2} y}{ⅆ {q}^{2}} - \frac{ⅆ y}{ⅆ q} \frac{{ⅆ}^{2} x}{ⅆ {q}^{2}}}{\sqrt[3]{{( \frac{ⅆ x}{ⅆ q} )}^{2} + {( \frac{ⅆ y}{ⅆ q} )}^{2}}} & ( 8 ) \\ ω ( t ) = V κ ( t ) & ( 9 )\end{matrix}$$

The robotic safety markers are differential drive robots with two wheels and one caster. During a period of differential time, as shown in FIG. 17, the robot turns about a given radius by δΨ. Here, S_{L} and S_{R} are the paths of the left and right wheels (and measured by the wheel encoders). No slip is assumed so the path lengths are related to the change in wheel angles (S=δθr where r is the wheel radius and δθ is given by the motor encoders). D is the distance between the wheels, and R_{L} and R_{R} are the turning radii for each wheel. Now, given the desired linear velocity and angular velocity of the follower robot, the angular velocities of left and right wheels are obtained from Eq. (10) using the robot's kinematics:

$$\begin{matrix}{ω}_{L} = \frac{2 V - {ω}_{D}}{2} \\ {ω}_{R} = \frac{2 V + {ω}_{D}}{2} Where \\ V = \frac{{V}_{L} + {V}_{R}}{2} \\ ω = \frac{{V}_{R} - {V}_{L}}{D} And \\ {V}_{L} = {ω}_{L} r = \frac{{δθ}_{L}}{δ t} r , {V}_{R} = {ω}_{R} r = \frac{{δθ}_{R}}{δ t} r\end{matrix} \qquad ( 10 )$$

A PID velocity controller is thus designed for each robotic safety marker 200 to control the wheel angular velocity of the follower robot. Therefore, the follower robot 200 can follow the defined Bezier trajectory with the desired linear velocity by controlling the angular velocity of each wheel.

It is to be understood that the specific embodiments of the present invention that are described herein is merely illustrative of certain applications of the principles of the present invention. It will be appreciated that, although an exemplary embodiment of the present invention has been described in detail for purposes of illustration, various modifications may be made without departing from the spirit and scope of the invention. Therefore, the invention is not to be limited except as by the appended claims.

What is claimed is:

1. A robotic highway safety marker system comprising:
(a) a base station having means for localization, a communication module and means for path planning;
(b) one or more robotic safety markers, each robotic safety marker comprising a motorized set of wheels, and a safety marker communication module;
(c) whereby the base station locates each safety marker and communicates a marker specific wireless signal to each safety marker to control a path of the safety marker.

2. The system of claim 1, wherein the base station is an autonomous mobile master robot and further includes a processor.

3. The system of claim 1, wherein the means for localization comprises a range finder module.

4. The system of claim 3 wherein the range finder module is a non-contact laser measurement system that locates the distance from the base station for each of the one or more robotic safety markers.

5. The system of claim 4 wherein the means for localization further comprises a compass module mounted in each of the one or more robotic safety markers.

6. The system of claim 1, wherein the means for localization comprises a first global positioning receiver mounted to the base station and one or more second global positioning receivers mounted in each of the one or more robotic safety markers.

7. The system of claim 2, wherein the communication module for the master robot is a frequency hopping spread spectrum wireless module and wherein the module enables communication between the master robot and the safety marker communication module for each of the one or more robotic safety markers.

8. A method for controlling one or more robotic highway safety markers from a base station comprising the steps of:
(a) localizing each of the one or more robotic highway markers;
(b) inputting a final position for each of the one or more robotic highway markers;
(c) planning a path for each of the one or more robotic safety highway markers;
(d) sending a command consisting of a waypoint to a first robotic safety marker from the base station; and
(e) executing the movement for the first robotic safety marker to the way point.

9. The method of claim 8 wherein the step of localizing each of the one or more robotic highway markers comprises calculating the location of each of the one or more robotic highway markers relative to the base station using a laser measurement device mounted on the base station and further comprises determining the orientation of each of the one or more robotic safety markers.

10. The method of claim 9 wherein the step of localizing each of the one or more robotic highway markers further comprises the steps of scanning a range for each of the one or more robotic highway markers using the laser measurement device of the base station, applying a Hough transform to the data from the scan, extracting circles from the data to determine the location of the one or more robotic highway markers relative to the base station.

11. The method of claim 8 wherein the base station is an autonomous mobile robot.

12. The method of claim 9 wherein the step of planning a path for each of the one or more robotic safety highway markers comprises the steps of:
(a) providing a central processing unit for the base station;
(b) providing the central processing unit with the location and orientation of each of the one or more robotic highway markers;
(c) inputting a final position for each of the one or more robotic highway markers; and
(d) determining a path for each of the one or more robotic highway markers.

13. The method of claim 12 wherein the step of executing the movement for the first robotic safety marker to the way point further comprises the steps of:
(i) determining the first robotic markers heading information from a compass module;
(ii) calculating the movements for the robotic safety marker to guide the robot to the waypoint; and
(iii) generating commands to a pair of motors, each operating a wheel of the first robotic safety marker to move the first robotic safety marker to the waypoint.

14. The method of claim 8 wherein the step of sending a signal consisting of a waypoint to a first robotic safety marker from the base station comprises the steps of:
(i) assembling points from a serial port buffer of the first robotic safety marker into a message;
(ii) validating the message to determine if the message was intended for the first robotic marker; and
(iii) processing the message.

15. A method for controlling one or more robotic highway safety markers from a lead station comprising the steps of:
(a) localizing each of the one or more robotic highway markers;
(b) assigning a virtual destination for each robotic highway safety marker;
(c) defining a trajectory between each robotic highway safety marker and the virtual destination corresponding to the highway safety marker;
(d) updating this trajectory in real time as the lead station moves; and
(e) communicating data related to the Bezier trajectory and the velocity of the lead station from the lead station to each robotic highway safety marker.

16. The method of claim 15 wherein the step of localizing each of the one or more robotic highway markers comprises calculating the distance of each of the one or more robotic highway markers using a laser measurement device mounted on the lead station.

17. The method of claim 15 wherein the step of localizing each of the one or more robotic highway markers comprises the steps of:
(i) providing each robotic highway marker with a global positioning receiver;
(ii) providing the lead station with a global positioning receiver;
(iii) communicating to the lead station each robotic highway marker's global position; and
(iv) calculating the location of each of the one or more robotic highway markers.

18. The method of claim 15 wherein each robotic safety marker includes a pair of wheels driven by a pair of motors and the method further comprises the step of:
(f) providing a PID velocity controller for each robotic safety marker to control wheel angular velocity for each robotic safety marker, the controller being responsive to commands from the lead station.

19. The method of claim 15 wherein the trajectory is a Bezier trajectory.

20. A robotic safety marker system comprising:
(a) one or more follower safety markers, each robotic safety marker comprising a motorized set of wheels, a compass module, and a safety marker communication module;
(b) an intelligent lead station having a processor, a means for localization of each of the one or more robotic safety markers, a communication module for master-slave communication with each of the robotic safety markers and means for path planning; and
(c) whereby the lead station localizes each follower safety marker and communicates a command to each safety marker to control a path of the safety marker such that each of the one or more follower safety markers follow the lead station along a path.

21. The system of claim 20, wherein the lead station is an autonomous mobile robot and wherein means for localization of each follower safety marker comprises a range finder module to determine the distance data from the lead station of each of the one or more follower safety markers and the processor applying a Hough transform analysis of the distance data to localize each safety marker.

22. The system of claim 20, wherein the lead station is an autonomous mobile robot and wherein means for localization of each follower safety marker comprises a global positioning receiver module for each follower safety marker and the lead station, and whereby the follower safety markers communicate their location and orientation to the lead station for localization of each follower safety marker.

23. The system of claim 20 wherein each follower safety marker further includes proportional-integral-derivative velocity controller.

24. The system of claim 20 wherein the means for path planning comprises the processor determining a virtual destination for each robotic highway safety marker and defining a Bezier trajectory between each robotic highway safety marker and the virtual destination corresponding to the highway safety marker.
